(19) United States
(12) Patent Application Publication
(10) Pub. No.: US 2004/0025405 A1
(43) Pub. Date: Feb. 12, 2004

(54) Bait for trolling

(76) Inventor: Jose Antonio Rivera Gomez, Alicante (ES)

Correspondence Address: OSTROLENK FABER GERB & SOFFEN, 1180 AVENUE OF THE AMERICAS, NEW YORK, NY, 100368403

(21) Appl. No.: 10/638,072

(22) Filed: Aug. 8, 2003

(30) Foreign Application Priority Data
Aug. 8, 2002 (ES) 200202023

(51) Int. Cl. A01K 85/00

(52) U.S. Cl. 43/42.12

(57) ABSTRACT

A bait for trolling, constituted of a significantly cylindrical, although slightly barrel-shaped, hollow and frontally open body (1). On the inside thereof, a cone-shaped core (3) is assembled in which, by means of a shaft (5), a freely rotational propeller (6) is assembled. The body is provided with a plurality of side holes (7) connecting with the inside.

### OBJECT OF THE INVENTION

The present invention refers to a bait specially designed for trolling, a bait which generates two complementary attracting signals for fish, an acoustic signal and an optical signal, making it highly attractive.

Thus, while the vessel navigates and the fishing tackle is dragged by the stern, the bait is identified by the fish as a cephalopod in movement.

### DESCRIPTION OF THE INVENTION

For this purpose and more specifically, the bait proposed by the invention is constituted by means of a cylindrical although slightly barrel-shaped hollow, frontally open head, with a cone-shaped inner core, frontally finished in a short shaft for a propeller which rotates at a high speed when the bait is moved due to the effect of the water current passing through it, such that said propeller generates a certain sound in its movement which is complemented by another sound, in turn generated by the intermittent outflow of water through four side-rear and equiangularly distributed holes placed in correspondence with the widest area of the cone-shaped core, such that the combination of these two sounds generates a third sound which is highly attractive for fish.

Complementarily, the intermittent jets of water through the side-rear holes generate likewise intermittent wakes which, together with the head itself of the bait, make the latter visually resemble a cephalopod, such as an octopus, for example, a visual bait which can be enhanced with the collaboration of a tail fixed to the rear end of the body and materialized in a group of filaments of a flexible and undulating material with the shape of tentacles.

Also with an optional character, the bait may incorporate respective triangular-shaped stabilizer fins in two diametrically opposite points of the head thereof.

### DESCRIPTION OF THE DRAWINGS

To complement the description being made and for the purpose of helping to better understand the features of the invention according to a preferred practical embodiment example thereof, a set of drawings is attached to said description as an integral part thereof which, with an illustrative and non-limiting character, show the following:

FIG. 1 shows, according to a perspective schematic view, a bait for trolling carried out according to the object of the present invention, specifically according to the simplest embodiment variant for the same, in which the bait lacks a tail as well as stabilizer fins.

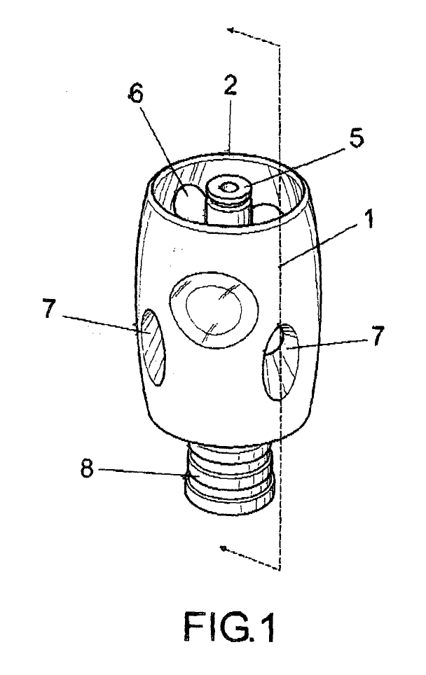

FIG. 2 shows a view similar to that of the previous figure, corresponding to a bait with a tail and stabilizer fins.

FIG. 3 shows a diametric sectional view of the bait of FIG. 1.

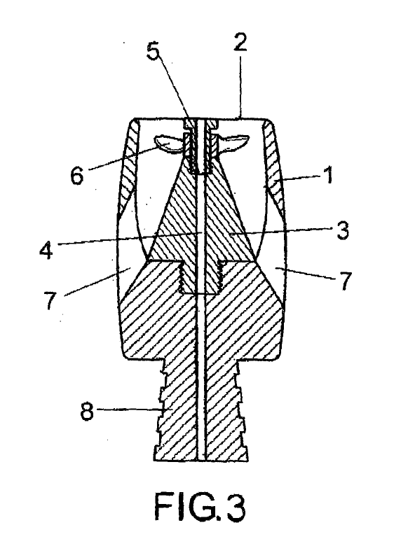

### PREFERRED EMBODIMENT OF THE INVENTION

In view of the indicated figures, it can be seen how the proposed bait is constituted as from a body (1) tending to have a hollow, cylindrical shape and open at its frontal end (2) for permitting water to access the inside thereof, in which cavity a cone-shaped core (3) is arranged, with an axial hole (4) usable, for example, for the passing of the fixing means of the bait, and which in either case houses at its vertex or first end a short shaft (5) on which a propeller (6) is assembled with rotational freedom, which propeller is closely introduced with regard to the opening (2) of the body (1) and which is actuated by the water current passing through the body.

As a complement to the described structure, said body (1) incorporates on its rear end, the one corresponding to the widest area of the cone-shaped core (3), a group of side holes (7) for the outflow of water, preferably four equiangularly distributed holes, such that the water accessing the bait through its opening when the bait is dragged flows outwardly again through said holes (7).

The circulation of water through the inside of the bait implies as a consequence, as previously mentioned, a high speed rotation of the propeller (6), as well as the forced outflow of water through holes (7), generating two different sounds, one sound by the propeller (6) itself in is rotation and another sound by the jets of water flowing out through holes (7), wounds which, when combined, generate a sound that is highly attractive for fish.

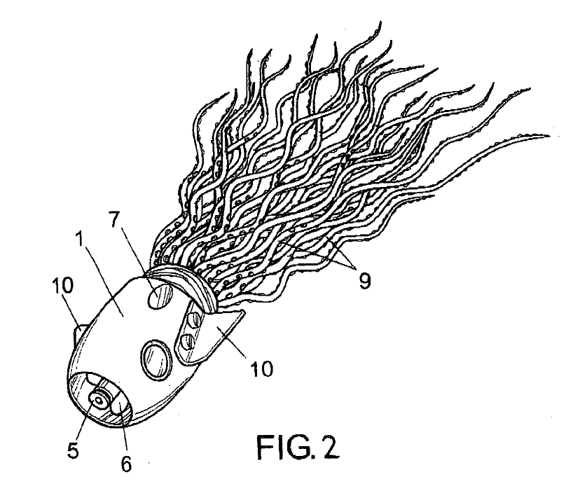

The cone-shaped core (3) extends beyond the body (1), at its rear end, in an attachment (8) which is usable, as in the practical embodiment example shown in FIG. 2, so as to provide the bait with a tail composed of a plurality of filaments (9) of a flexible and undulating material, similar to tentacles, making the entire bait resemble, in this case, a cephalopod, specifically a small octopus.

The body (1) can also be optionally provided with a pair of diametrically opposed side fins (10) acting as stabilizer means of the bait in the movement thereof due to the effect of the corresponding dragging element.

1. A bait for trolling, characterized by being constituted as from a significantly cylindrical, although slightly barrel-shaped, hollow and frontally open body (1), in which cavity a cone-shaped core (3) is arranged with a vertex oriented towards its opening (2) and closely introduced with regard to the latter, to which core a short shaft (5) is fixed which is coaxial with the body itself, on which shaft a propeller (6) is assembled with rotational freedom which rotates at a high speed due to the water current passing through the head when it moves in the water, whereas at a rear level said body incorporates a plurality of side holes (7), preferably four equiangularly distributed holes, constituting the outlet for the water moving the propeller (6), all this such that the propeller generates a certain sound which, combined with another sound generated by the forced jets of water flowing out of said holes, determine a subsequent sound attractive for fish.

2. A bait for trolling according to claim 1, characterized in that a plurality of filaments (9) of a flexible and undulating material are fixed to the rear end (8) of the body (1), which resemble tentacles providing the entire bait with the appearance of a cephalopod.

3. A bait for trolling according to previous claims, characterized in that the body (1) laterally incorporates a pair of stabilizer fins (10) in diametric opposition.
